(19) United States
(12) Patent Application Publication
(10) Pub. No.: US 2013/0008972 A1
(43) Pub. Date: Jan. 10, 2013

(54) Anti-skid mats for facilitating movement of a vehicle on a slippery surface, a method of manufacturing thereof, and a method for manufacturing an anti-skid mat's material

(76) Inventor: Joel Edwin Lubinitsky, Forest Hills, NY (US)

(21) Appl. No.: 13/135,519

(22) Filed: Jul. 8, 2011

(51) Int. Cl. E01B 23/00; B29C 33/38; E01C 11/24

(52) U.S. Cl. 238/14; 264/219

(57) ABSTRACT

Disclosed herein are an anti-skid mats for facilitating movement of a vehicle on a slippery surface such as ice, snow, including deep friable snow, and the like, and a method of manufacturing thereof. Disclosed is a method for manufacturing an anti-skid mat's material. Presented an anti-skid mats have a dual function: a function of a means for facilitating movement of a vehicle on a slippery surface and a function of a cars' bumper's protector.

### BACKGROUND OF THE INVENTION

1. Field of the Invention

The present invention relates generally to slip-resistant devices and more specifically it relates to anti-skid mats.

2. Description of the Prior Art

Numerous slip resistant devices have been provided in prior art. For example, U.S. Pat. Nos. 7,350,719; 7,404,524; 4,061,268; 4,931,330; 5,601,900; 5,204,159; 4,795,093 all are illustrative of such prior art. While these units may be suitable for the particular purpose to which they address, they would not be as suitable for the purposes of the present invention as heretofore described.

### Inventor: Brenner; Eugene

Vehicle traction device
U.S. Pat. No. 7,350,719

An inventive traction device is provided for extricating mired vehicles from mud, snow or sand. The device is comprised of modules linked together to create a track upon which a mired vehicle drives over. The individual modules each have four walls forming a trough and a number of tire supports which rise up from the floor of the trough. The trough-like construction of the device helps prevent the device from becoming overloaded with mud deposited from mired vehicle tires.

Despite a number of useful properties, the disadvantage of the device is its inconvenience, laboriousness of production, as well as trauma to the people of its protruding parts and swivels.

### Inventor: Mathieu; Serge

Traction aid device
U.S. Pat. No. 7,404,524

A traction aid for providing traction to a wheel of a vehicle relative a ground surface has two sections, composed of side members and traction members, connected by a connecting mechanism enabling pivotal unfolding and folding of sections between folded and unfolded configurations for device. In unfolded configuration, sections are longitudinally opposed end-to-end to allow wheel to pass over both sections when device is deployed on ground surface. In folded configuration, sections are folded together and extend substantially parallel one another. Each section has a plurality of gripping members attached to side members and extending therefore. Each gripping member is configured such that, when device is deployed in unfolded configuration on ground surface, gripping member extends there towards for grippingly protruding thereinto, gripping member otherwise, for folded configuration, extending towards an adjacent side member of another section, the adjacent side member extending therebeyond to impede gripping member from engaging foreign objects.

Despite a number of useful properties, the disadvantage of the device is its inconvenience, as well as trauma to the people of its protruding parts and swivels.

### Inventor: DeMaster; Robert D.

### Traction mat

U.S. Pat. No. 4,061,268

A mat useful, inter alia, to provide traction under the wheels of a vehicle comprises an open-mesh net of strands that are encased around their individual circumferences with a frictional coating that comprises a layer of binder material adhered to the strand and a monolayer of abrasive granules partially embedded in the layer of binder material.

Such traction mat can be used on very dense snow or ice surface, however, at deep and friable snow possibility of its use is limited. Besides, a lack of this invention is complexity of manufacturing of the device.

### Inventors: Stier; Sam S., Kaufman; Robert E.

Prefabricated, slip-resistant surface coating.
U.S. Pat. No. 4,931,330

The invention relates to a prefabricated, slip-resistant surface coating which comprises a sheet member having a film on its surface, said film embedded therein in plurality of finely divided abrasive particles. This coating can be adapted to make a bathtub surface slip-resistant. However, the presented invention cannot be used for skidding prevention wheeled vehicles on snow as manifests the slip-resistant properties only at a covering of an equal firm surface.

### Inventor: Doscher; Herbert

### Anti-skid mat

U.S. Pat. No. 5,601,900

An anti-skid mat for placement upon a slippery support surface comprising a resilient matrix sheet member having a top surface and a bottom surface. An abrasive structure on the bottom surface of the resilient matrix sheet member is for preventing slippage of the resilient matrix sheet member on the slippery support surface. This forms a safe walkway for a person, when the person steps upon the top surface of the resilient matrix sheet member.

However, the present invention also cannot be used to prevent slippage wheeled vehicles on snow, as reveals the slip-resistant properties only cover a flat hard surface.

### Inventor: Tan; Domingo K. L.

Deformable, slip-free, anti-skid pads for snow and ice
U.S. Pat. No. 5,204,159

A deformable slip-free, anti-skid pad comprising: a bottom surface having a plurality of spikes slightly extending vertically from recessed areas of the bottom surface; and a top surface comprising a resilient material having imbedded therein particles of abrasive materials. However, this invention can be used for pedestrians, but cannot be used for vehicles, because spikes are not able to keep the pad from moving in a horizontal direction under the influence of the rotating wheels of vehicles in fresh or crumbly snow, but on thin ice—the spikes are able to penetrate it and damage the road surface.

### Inventor: Kozelnicky; Edward D.

Traction/sanding device for wheeled vehicles
U.S. Pat. No. 4,795,093

A traction/sanding device for a wheeled vehicle provides a traction strip attached at one narrow edge to an inflated, breakable container filled with an abrasive substance. The traction strip defines a package wrapping container which protects the container prior to use, preferably in the form of a cardboard box which is unfolded to extend the traction strip. In use, the strip is placed at the intersection of the tire and the road surface, gripper tabs towards the tire. Tire movement, even if spinning draws the strip under the tire, pulling the container underneath until the weight of the vehicle breaks the container, spilling the abrasive substance on the ground to give an area of improved traction.

This device can be successfully used on an ice-covered surface; however its lack is disposable use and impossibility of use on deep friable snow.

### SUMMARY OF THE INVENTION

A primary object of the present invention is to provide an anti-skid mat that will overcome the shortcomings of the prior art devices.

Another object is to provide an anti-skid mats for facilitating movement of a vehicle on a slippery surface such as ice, snow, including deep friable snow, and the like, and a method of manufacturing thereof.

An additional object is to provide an anti-skid mat that may be made from finished goods, recycled and natural materials, and may be reusable.

An additional object is to provide an anti-skid mat that may be made from goods which have served their resource.

An additional object is to provide an anti-skid mat being environmentally friendly.

An additional object is to provide a method for manufacturing an anti-skid mat's material.

A further object is to provide an anti-skid mat that is simple and easy to use.

A still further object is to provide an anti-skid mat that is economical in cost to manufacture.

A still further additional object is to provide an anti-skid mat that has a dual function: as a means for facilitating movement of a vehicle on a slippery surface and as a cars' bumper's protector.

Further objects of the invention will appear as the description proceeds.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWING FIGURES

Various other objects, features and attendant advantages of the present invention will become more fully appreciated as the same becomes better understood when considered in conjunction with the accompanying schematic drawings, in which like reference characters designate the same or similar parts throughout the several views, and wherein:

FIG. 1a—diagrammatic shows a perspective view of a first embodiment of the present invention.

FIG. 1b—diagrammatic shows a cross section of an anti-skid mat where are visible a granular substance is poured into receptacle made from a flexible material.

FIG. 2—diagrammatic shows another embodiment of the present invention. It is a cross sectional view of a fragment of the anti-skid mat where it's receptacle has an envelope from a frictional material located outside of said receptacle

FIG. 3—diagrammatic shows alternative (FIG. 2) embodiment of the present invention. It is a cross sectional view of a fragment of the anti-skid mat where it's receptacle is made from a fabric grinding ribbon with the tightened abrasive particles, at least, on its external surface.

FIG. 4—diagrammatic shows a fragment of another embodiment of the present invention with a cross section of an anti-skid mat where are visible a granular substance is poured into receptacle made from an air-locked material, which has hollows on external surface.

FIG. 5—diagrammatic shows a fragment of still another embodiment of the present invention. It is a cross sectional view of fragment wherein it is reinforced by a reinforcing fabric from a flexible material located into said material.

FIG. 6a—diagrammatic shows another embodiment of the present invention. It is a perspective view of that embodiment wherein reinforcing fabric is located into material of the receptacle, thus that the thickness of a wall of said receptacle in the field of the elements forming a set group of cells said reinforcing fabric, exceeds a thickness of a wall of said receptacle in corresponding set group of cells.

FIG. 6b—diagrammatic shows a cross sectional view of a fragment of a wall of the anti-skid mat's receptacle which reinforced by a reinforcing fabric thus that the thickness of a wall of said receptacle in the field of the elements forming a set group of cells said reinforcing fabric, exceeds a thickness of a wall of said receptacle in corresponding set group of cells.

FIG. 6c—diagrammatic shows a cross sectional view of a fragment of a wall of the anti-skid mat's receptacle wherein hollows are formed in such a way that the top-hollows located not over bottom-hollows.

FIG. 7a—diagrammatic shows another embodiment of the present invention. It is a perspective view of that embodiment wherein a reinforcing fabric is made in the form of an envelope located outside of anti-skid mat's receptacle.

FIG. 7b—diagrammatic shows a cross sectional view of a fragment of another embodiment of the present invention wherein a reinforcing fabric is made in the form of an envelope located outside of anti-skid mat's receptacle and in the form of a liner located inside of anti-skid mat's receptacle.

FIG. 8a—diagrammatic shows still another embodiment of the present invention. It is a perspective view of that embodiment wherein an anti-skid mat's receptacle is made from one hose.

FIG. 8b—diagrammatic shows an alternative embodiment of the present invention. It is a perspective view of that embodiment wherein an anti-skid mat's receptacle is made from two or more hoses and said hoses are fastened in such a manner that organize uniform segmented anti-skid mat.

FIG. 8c—diagrammatic shows a perspective view of an alternative embodiment of the present invention, wherein an anti-skid mat's receptacle is made from two or more hoses and said hoses are fastened in such a manner that organize uniform segmented anti-skid mat. In this embodiment the means for a fastening said hoses among themselves made in a form of a crosslinking or binding.

FIG. 8d—diagrammatic shows still another embodiment of the present invention. It is a diagrammatic view of that embodiment wherein an anti-skid mat's receptacle is made from a hose and wherein said hose is made in the form of a coil, and separate segments of said coil are fastened in such a manner that organize uniform segmented anti-skid mat.

FIG. 9a, b—diagrammatic shows next embodiment of the present invention. It is a perspective view of that embodiment wherein an anti-skid mat's receptacle is made by means mutual stranding of the longitudinal and transverse hoses and said hoses are fastened in such a manner that organize uniform segmented anti-skid mat.

FIG. 9c—diagrammatic shows a fragment of next embodiment of the present invention. It is a cross sectional view of a fragment of that embodiment wherein an anti-skid mat's receptacle is made from the hoses arranged in overlap and said hoses are fastened in such a manner that organize uniform segmented anti-skid mat.

FIG. 10—diagrammatic shows another embodiment of the present invention. It is a perspective view of that embodiment wherein at least a bottom wall of said receptacle of said anti-skid mat is crimped.

FIG. 11—diagrammatic shows another embodiment of the present invention. It is a perspective view of that embodiment wherein said receptacle of said anti-skid mat is made from one crimped hose.

FIG. 12a—diagrammatic shows still another embodiment of the present invention. It is a perspective view of that embodiment wherein an anti-skid mat's receptacle is made from two or more crimped hoses and said hoses are fastened in such a manner that organize uniform segmented anti-skid mat.

FIG. 12b—diagrammatic shows an alternative of the present invention. It is a perspective view of that embodiment wherein an anti-skid mat's receptacle is made from one crimped hose, said hose is made in the form of a coil, and separate segments of said coil are fastened in such a manner that organize uniform segmented anti-skid mat.

FIG. 13—diagrammatic shows still another embodiment of the present invention. It is a perspective view of that embodiment wherein an anti-skid mat's receptacle is made from a material, with the protuberances and protuberances directed outside of the receptacle. Also protuberances can directed inside of the receptacle (did not show).

FIG. 15a—diagrammatic shows still another embodiment of the present invention. It is a perspective view of that embodiment wherein an anti-skid mat providing with a means for fixing over a car bumper.

FIG. 15b—diagrammatic shows an alternative embodiment of the present invention. It is a perspective view of that embodiment wherein an anti-skid mat providing with an anti-skid mat's cover providing with a means for fixing said cover with placed inside said anti-skid mat over a car bumper.

FIG. 16—diagrammatic shows how an anti-skid mat works.

### DESCRIPTION OF THE PREFERRED EMBODIMENTS

### The Accepted Terms

As used herein, the term “a granular substance” takes on its commonly understood meaning in the art, and refers to any type and equivalents of a granular material, both natural, and an artificial origin. A granular material is a conglomeration of discrete solid macroscopic particles characterized by a loss of energy whenever the particles interact. For example, different kinds of sand refer to such particles: mountain, river, quartz, sea, career and others. On a size of grains sand can be classified: coarse-grained (3 MM and more), medium-grained (2-3 MM), thin or fine-grained (to 2 MM). For the present invention it can be applied, both sand of all fractions, and small rubble and gravel with grains coarseness from 5 to 10 mm. Also for the purpose of the present invention can be used seed, crushed seed, crushed wood, a pit's crumb, a small cockleshell, metal, non-metal, composite materials granules and their combination etc.

The term “a reinforcing fabric” as used herein takes on its commonly understood meaning in the art, and refers to any type and equivalents of structure designed for reinforcing materials. For example, such equivalent terms in this value can be: a reinforcing mesh, a reinforcing net, reinforcing netting; a reinforcing grid etc. A reinforcing fabric can be made from the metal, non-metal, composite materials and their combination.

The term “a flexible material” for a receptacle as used herein takes on its commonly understood meaning in the art, and refers to any type and equivalents of a flexible material. A flexible material can be from woven, nonwoven, composite materials and their combination. In the capacity of materials for a receptacle bagging, a canvas, a tarpaulin, synthetic fabrics, polymeric materials, etc. can be used.

### Now Turning to the Drawings.

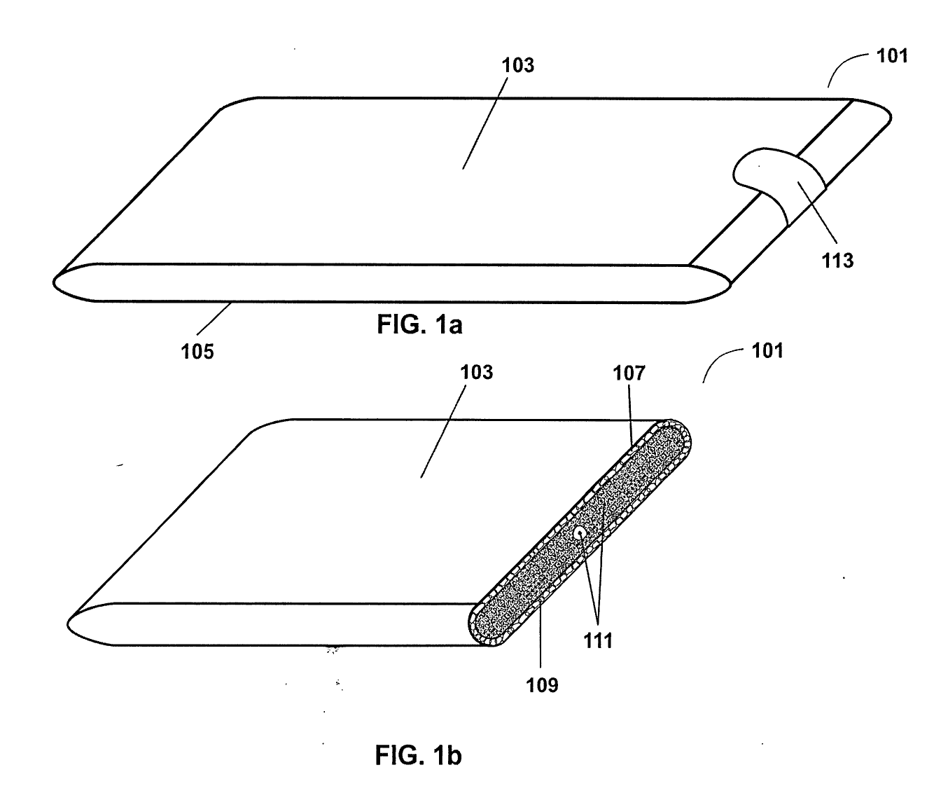

FIG. 1a—diagrammatic shows a perspective view of a first embodiment of the present invention.
FIG. 1b—diagrammatic shows a cross section of an anti-skid mat where are visible a granular substance is poured into receptacle made from a flexible material.
On FIG. 1 (a, b):
101—an anti-skid mat with a receptacle from a flexible material;
103—the top surface of the receptacle;
105—the bottom surface of the receptacle;
107—the top wall of the receptacle;
109—the bottom wall of the receptacle;
111—a granular substance poured into receptacle.

On FIG. 1a—the closable opening 113 of the receptacle shown in off condition.

On the FIGs an anti-skid mat 101 for facilitating movement of a vehicle on a slippery surface having a top surface 103 and a bottom surface 105, wherein said anti-skid mat is made as a receptacle from a flexible material into which a granular substance 111 is poured in and wherein said receptacle of said anti-skid mat is segmented or nor segmented (not shown).

An anti-skid mat's receptacle can be provided by a closable opening 113 of the receptacle for possibility of substitution or replenishment of said granular material.

The thickness an anti-skid mat can fluctuate, but not be restricted to limits from 10 mm to 70 mm depending of a kind of a granular substance and weight of a vehicle, however, the most universal are an anti-skid mats thickness from 15 mm to 50 mm.

A method for manufacturing an anti-skid mat comprising the steps of: a) making a receptacle from a flexible material, b) filling said receptacle by a granular substance, c) closing said receptacle.

An anti-skid mat's receptacle can be made from a slip resistant material and/or covered with an anti-skid coating.

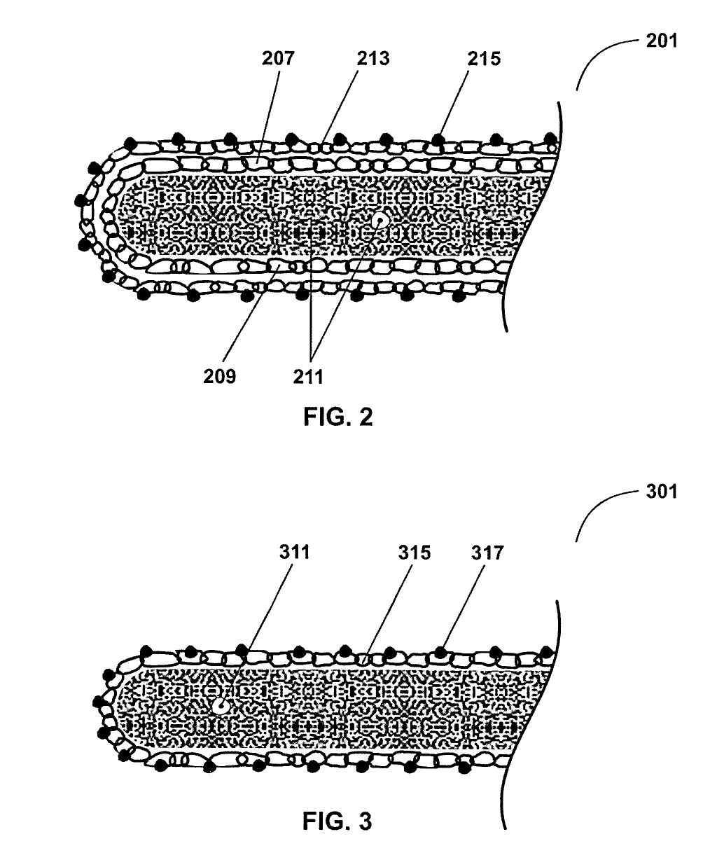

FIG. 2-diagrammatic shows another embodiment of the present invention. It is a cross sectional view of a fragment of the anti-skid mat where it's receptacle has an envelope 213 from a frictional material located outside of said receptacle. An envelope 213 provided with tightened abrasive particles 215 go beyond from its surface. Such performance a receptacle improves the clutch between wheels of a vehicle and a surface of mat, and between top surface of receptacle and an envelope from a frictional material.

### On FIG. 2:

201—an anti-skid mat;
207—the top wall of the receptacle;
209—the bottom wall of the receptacle;
211—a granular substance poured into receptacle;
213—an envelope from a frictional material located outside of said receptacle;
215—the tightened abrasive particles on the envelope.

FIG. 3—diagrammatic shows alternative (FIG. 2) embodiment of the present invention. It is a cross sectional view of a fragment of the anti-skid mat where it's receptacle is made from a fabric grinding ribbon 315 with the tightened abrasive particles 317, at least, on its external surface.

### On FIG. 3:

301—an anti-skid mat with a receptacle from a flexible material, which is made from a fabric grinding ribbon 315 with the tightened abrasive particles 317, at least, on its external surface;
311—a granular substance poured into receptacle of the anti-skid mat;
315—a grinding ribbon, with the tightened abrasive particles 317, at least, on its external surface. Such performance a receptacle not only improves the clutch between wheels of a vehicle and a surface of mat, but illustrates an instance of use of a finished material—fabric grinding ribbon, for manufacturing of anti-skid mats.

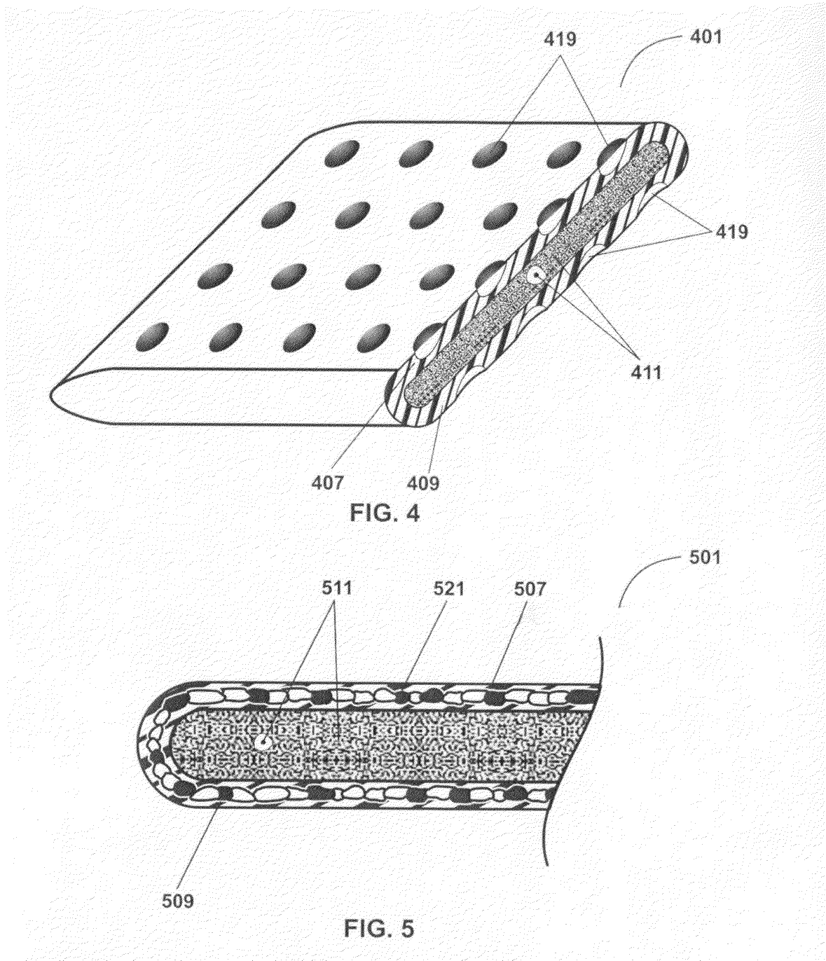

FIG. 4—diagrammatic shows a fragment of another embodiment of the present invention with a cross section of an anti-skid mat where are visible a granular substance is poured into receptacle made from an air-locked material, and the bottom wall and/or the top wall of said anti-skid mat's receptacle has hollows on the external and/or the internal (not shown) side.

If the hollows are formed on the internal surface of an anti-skid mat's receptacle the granular substance under pressure of vehicle concentrate the pressure on a bottom surface of an anti-skid mat predominantly into the hollows. At that coupling an anti-skid mat with a contacting slippery surface of the iced and snow over a road thus improves.

If an anti-skid mat's receptacle is made from an air-locked material, at pressure of a vehicle on the anti-skid mat on the external surface of anti-skid mat in hollows 419 the vacuum is created. The coupling of an anti-skid mat with a contacting surface of the iced over road and/or with vehicle wheels thus improves. Also a granular material 411 concentrates pressure vehicle in area around hollows on the external surface that also promotes the best ganging a contacting surface of the iced and snow over road and/or with vehicle wheels.

### On FIG. 4:

401—an anti-skid mat with a receptacle from a flexible and an air-locked material and said receptacle filled out with a granular substance;
407—the top wall of the receptacle;
409—the bottom wall of the receptacle;
411—a granular substance poured into receptacle of the anti-skid mat 401.
419—the hollows on external surface of the bottom and top walls of the anti-skid mat's receptacle.

FIG. 5-diagrammatic shows a fragment of still another embodiment of the present invention. It is a cross sectional view of fragment wherein it is reinforced by a reinforcing fabric from a flexible material located into said material.

### On FIG. 5:

501—an anti-skid mat with a receptacle is reinforced by a reinforcing fabric 521 from a flexible material located into said material;
507—the top wall of the receptacle;
509—the bottom wall of the receptacle;
511—a granular substance poured into receptacle.
521—a reinforcing fabric.

Such performance a receptacle improves strength, wear resistance and durability of the mat.

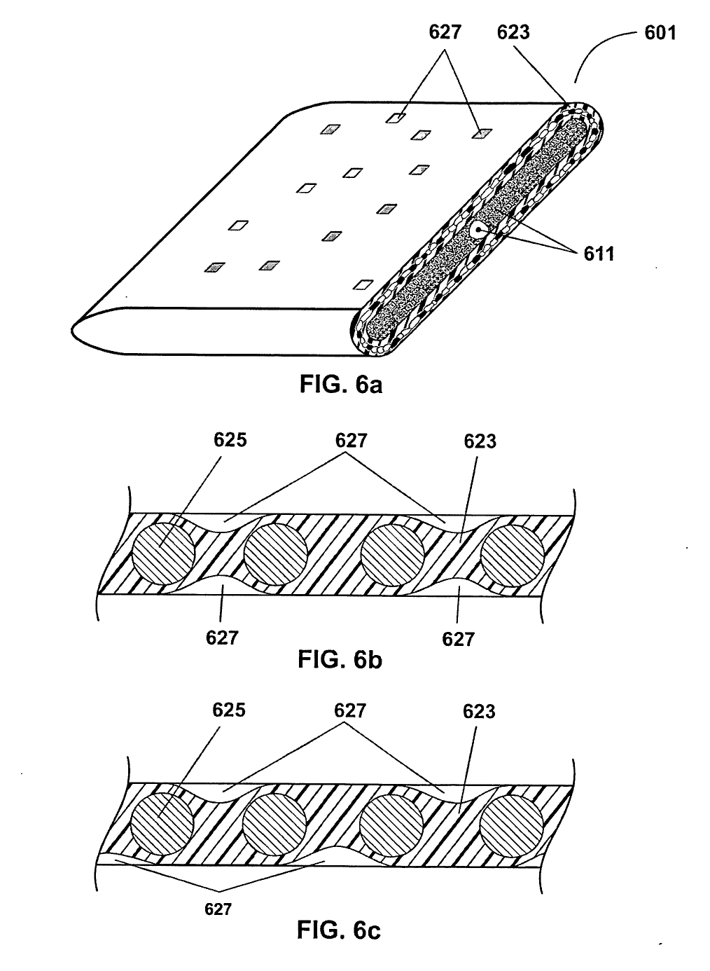

FIG. 6a—diagrammatic shows another embodiment of the present invention. It is a perspective view of that embodiment wherein reinforcing fabric is located into material of the receptacle, thus that the thickness of a wall of said receptacle in the field of the elements forming an adjust set group of cells said reinforcing fabric, exceeds a thickness of a wall of said receptacle in corresponding set group of cells.

An anti-skid mat's material receptacle is made from a flexible, air-locked and reinforced by a flexible reinforcing fabric material, thus said anti-skid mat's material is subjected to shaping, at least on one side, in area of an adjusted set group of cells for the purpose of deriving of hollows 627 inside cells of said set group.

Mainly in the capacity of a material it is used polymeric materials or rubber compositions.

The hollows inside cells of an adjust set group do by their formation under pressure of the ready reinforced sheets or films (tapes) by pressing, or it is direct in the course of manufacturing of the reinforced films (tapes) by a method of calendaring (not shown). Heating a material leads to increase in its pliability at formation by its transfer in plastic condition or elastic state. Pressure provides consolidation of a material and creation hollows a demanded configuration.

The material fabricated by such method can be used for manufacturing anti-skid mat's receptacles and immediately for manufacturing an anti-skid mats.

FIG. 6b—diagrammatic shows a cross sectional view of a fragment of a wall of the anti-skid mat's receptacle which reinforced by a reinforcing fabric thus that the thickness of a wall of said receptacle in the field of the elements 625 forming an adjust set group of cells said reinforcing fabric, exceeds a thickness of a wall of said receptacle in corresponding set group of cells. Therefore, in the field of adjust set cells on a surface of said receptacle of said anti-skid mat hollows 627 are formed.

FIG. 6c—diagrammatic shows a cross sectional view of a fragment of a wall of the anti-skid mat's receptacle wherein hollows 627 are formed in such a way that the top-hollows located not over bottom-hollows.

Formation of hollows in the set cells of a sheet (tape) material can be made thus that on the opposite side of a material against hollows eminences (not shown) will be formed.

If the hollows are formed on the inner surface of an anti-skid mat's receptacle the granular substance under pressure of vehicle concentrates the pressure on a bottom surface of an anti-skid mat predominantly in the hollows. At that coupling an anti-skid mat with a contacting slippery surface of the iced and snow over a road thus improves.

If an anti-skid mat's receptacle is made from an air-locked material, at pressure of a vehicle on the anti-skid mat on the external surface of anti-skid mat in hollows the vacuum is created. The coupling of an anti-skid mat with a contacting surface of the iced over road and/or with vehicle wheels thus improves. Also a granular material concentrates pressure vehicle in area around hollows on the external surface that also promotes the best ganging a contacting surface of the iced and snow over road and/or with vehicle wheels.

Thus, such performance a material for receptacles improves strength, wears resistance and durability of the mat and simultaneously allows to augment degree of ganging of an anti-skid mat with road and with wheels of vehicle.

On FIG. 6 (a, b, c):
601—an anti-skid mat with a receptacle from a flexible material which receptacle filled out with a granular substance 611;
623—the wall of the receptacle.
625—elements forming cells of the reinforcing fabric into material of the receptacle;
627—hollows on the surface of the material of the receptacle formed in the field of the cells of the reinforcing fabric.

For arranged more in sequence disposing particles of granular material in hollows (FIG. 6) a reinforcing fabric of anti-skid mat is made with the minimum cross size of a cell exceeding greatest fineness of grains of a granular substance in the following ratio of sizes, presented to the table:

| | |
|---|---|
| The fineness of grains, mm | The minimum cross size of a cell, mm |

| | |
|---|---|
| 0.7-2 | 5-7 |
| Over 2 up to 3 | 7-10 |
| Over 3 up to 10 | 12-20 |

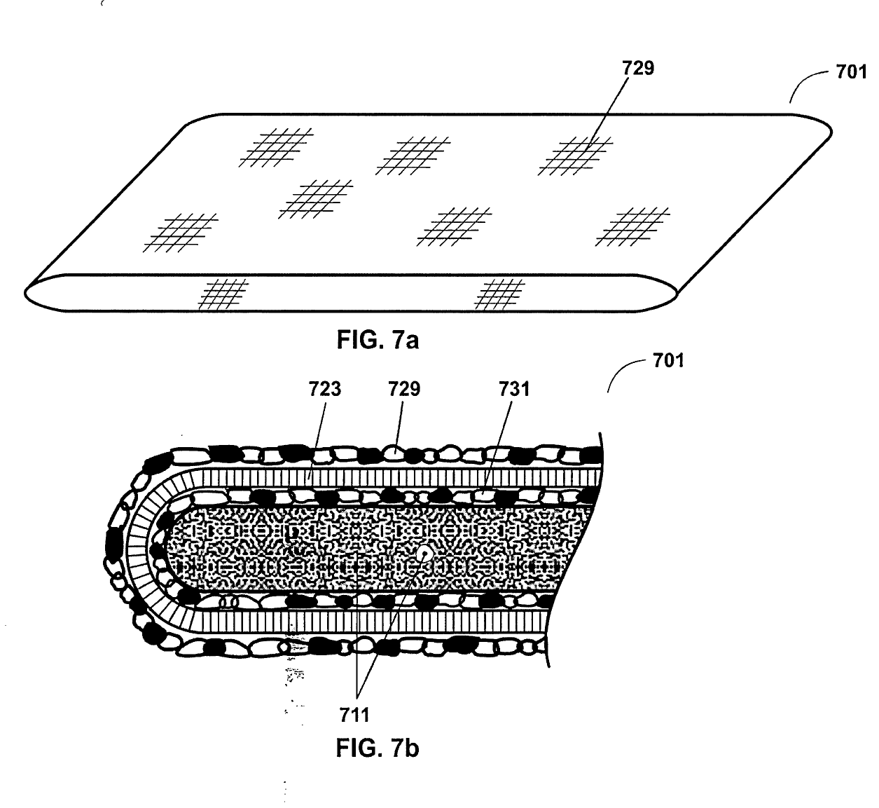

FIG. 7a—diagrammatic shows another embodiment of the present invention. It is a perspective view of that embodiment wherein a reinforcing fabric 729 is made in the form of an envelope located outside of anti-skid mat's receptacle.

FIG. 7b—diagrammatic shows a cross sectional view of a fragment of another embodiment of the present invention wherein a reinforcing fabric 729 is made in the form of an envelope located outside of anti-skid mat's receptacle and in the form of a liner 731 located inside of anti-skid mat's receptacle.

On FIG. 7 (a, b):
701—an anti-skid mat with a receptacle from a flexible material which receptacle filled out with a granular substance;
711—a granular substance poured into receptacle;
723—the wall of the receptacle;
729—a reinforcing fabric is made in the form of an envelope located outside of anti-skid mat's receptacle;
731—a reinforcing fabric is made in the form of a liner located inside of anti-skid mat's receptacle. An envelope 729 located outside of anti-skid mat's receptacle and made from a reinforcing fabric from the one hand improves the clutch between external surface of receptacle and an envelope, and on the other hand—improves the clutch between wheels of a vehicle and a surface of anti-skid mat. A liner 731 located inside of anti-skid mat's receptacle and made from a reinforcing fabric, under the pressure of wheels of a vehicle formed in the cells a separate portions of a granular material 711 which together with a reinforcing fabric concentrates pressure of wheels of a vehicle on anti-skid mat and on a slippery surface, raises a friction between receptacle and a granular material, and augments resistance shift migration a granular material inside receptacle under the influence of moving wheels of a vehicle. It also promotes ganging heightening anti-skid mat with a slippery surface.

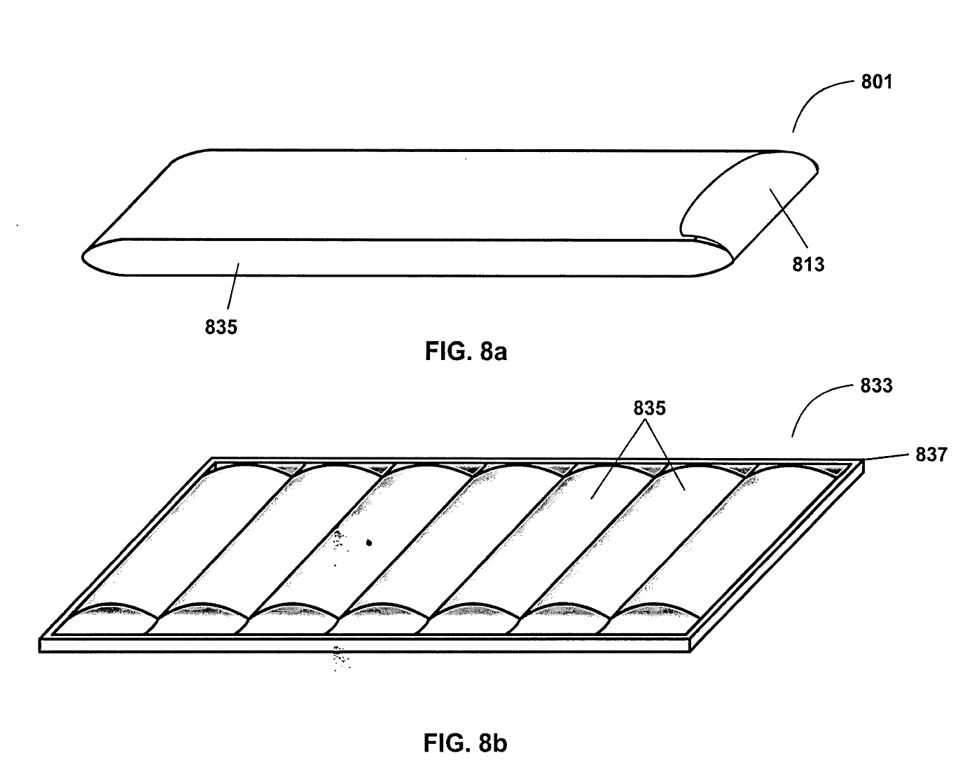

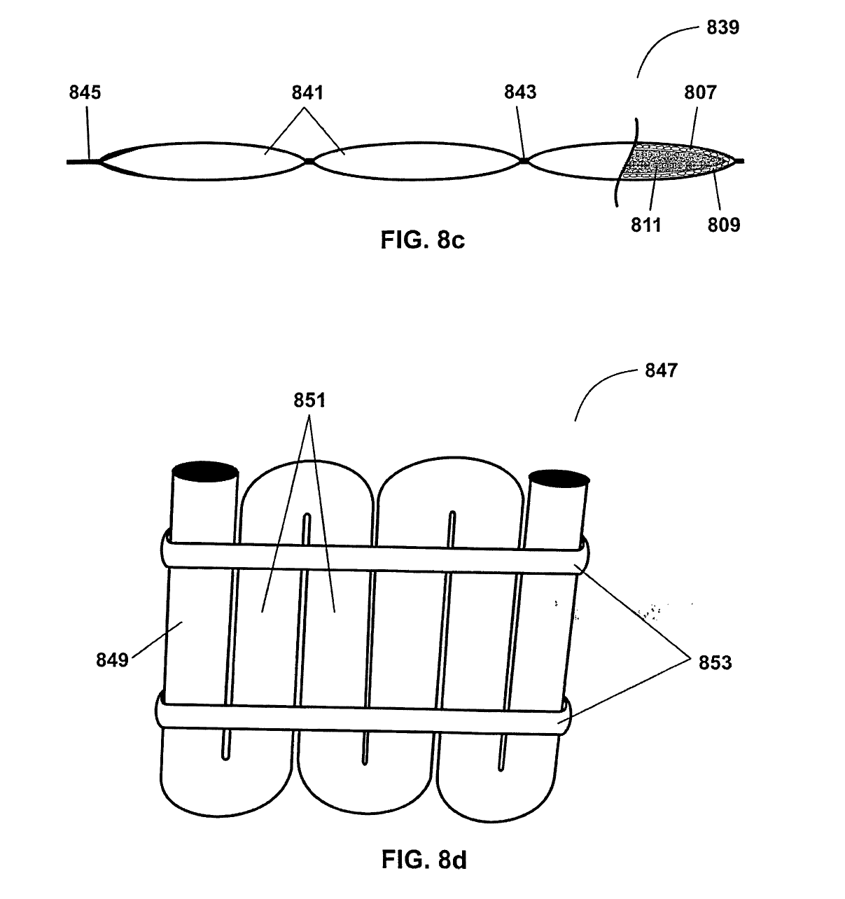

FIG. 8a—diagrammatic shows still another embodiment of the present invention. It is a perspective view of that embodiment wherein an anti-skid mat's receptacle is made from one hose. An anti-skid mat's receptacle can be made with a closable opening 813 (shown in off condition). Such performance a receptacle illustrates an instance of use of a finished material. Use worked out the resource of fire hoses for manufacture receptacle has the advantage and is an example of utilization of the worked out resource of goods.

It is necessary to mean that used for manufacturing an anti-skid mat's receptacles hoses, depending on their first shape and sizes, if necessary, can be flattened to or after filling up said receptacle by granular material.

FIG. 8b—diagrammatic shows an alternative embodiment of the present invention. It is a perspective view of that embodiment wherein an anti-skid mat's receptacle is made from two or more hoses 835 and said hoses are fastened in such a manner that organize uniform segmented anti-skid mat with segments 835. In this embodiment the means for fastening said hoses among themselves, made in the form of a framework 837.

In such a manner said fastened hoses, filled with granular material, organize uniform segmented anti-skid mat. Such performance a receptacle not only illustrates an instance of use of a finished material and a possibility of use worked out the resource of hoses, predominantly fire hoses, but improves the clutch between a surface of anti-skid mat and wheels of a vehicle on the one hand and a slippery surface on the other hand, because uniform segmented anti-skid mat under the influence of weight of a vehicle creates in a snow cover deeper indents, and more effectively resists to shift migrations granular material inside a receptacle under the influence of revolving wheels of a vehicle, and also resists to shift migrations of snow by an anti-skid mat more effectively.

FIG. 8c—diagrammatic shows a perspective view of an alternative embodiment of the present invention, wherein an anti-skid mat's receptacle is made from two or more hoses 841 and said hoses are fastened in such a manner that organize uniform segmented anti-skid mat. In this embodiment the means for a fastening said hoses among themselves made in a form of a crosslinking 843. In such a manner said fastened hoses, filled with granular material, organize uniform segmented an anti-skid mat. Similar anti-skid mat possesses specified at exposition FIG. 8b advantages, and besides, allows to lay down compactly anti-skid mat in a boot.

FIG. 8d—diagrammatic shows still another embodiment of the present invention. It is a diagrammatic view of that embodiment wherein an anti-skid mat's receptacle is made from a hose and wherein said hose is made in the form of a coil 849, and separate segments 851 of said coil are fastened in such a manner that organize uniform segmented anti-skid mat. In this embodiment the means for fastening said separate segments of said coil among themselves made in a form of belts 853.

In such a manner said hose, filled with granular material, organize uniform segmented an anti-skid mat. Similar anti-skid mat possesses specified at exposition FIG. 8b advantages, and besides, it is simpler in manufacturing.

On FIG. 8 (a, b, c, d):
801—an anti-skid mat wherein an anti-skid mat's receptacle is made from a hose with a closed or closable opening and which receptacle filled out with a granular substance;
807—the top and the bottom 809 walls of the receptacle;
811—a granular substance poured into receptacle;
813—a closable opening of the receptacle shown in off condition;
833—an anti-skid mat, which receptacle is made from two or more hoses and said hoses are fastened in such a manner that organize uniform segmented anti-skid mat;
835—hoses used for manufacturing of a receptacle for a granular substance;
837—a means for a fastening of filled out with a granular substance hoses among themselves, made in a form of a framework;
839—a diagrammatic view of image of anti-skid mat, which receptacle is made from two or more hoses and said hoses are fastened in such a manner that organize another kind of uniform segmented anti-skid mat in which hoses fastening among themselves by a stitching;
841—hoses, filled out with a granular substance, fastening among them by a stitching;
843—lock seam;
845—insertion part of a hose;
847—a diagrammatic image of an anti-skid mat which receptacle is made from one hose and wherein said hose is made in the form of a coil 849 filled out with a granular substance and wherein separate segments 851 of said coil are fastening with each other by a binding of belts 853.

In particular, an anti-skid mat's receptacles can be made from hoses which have served their resource, in particular fire hoses. Thus, hoses which have served their resource can be recycled.

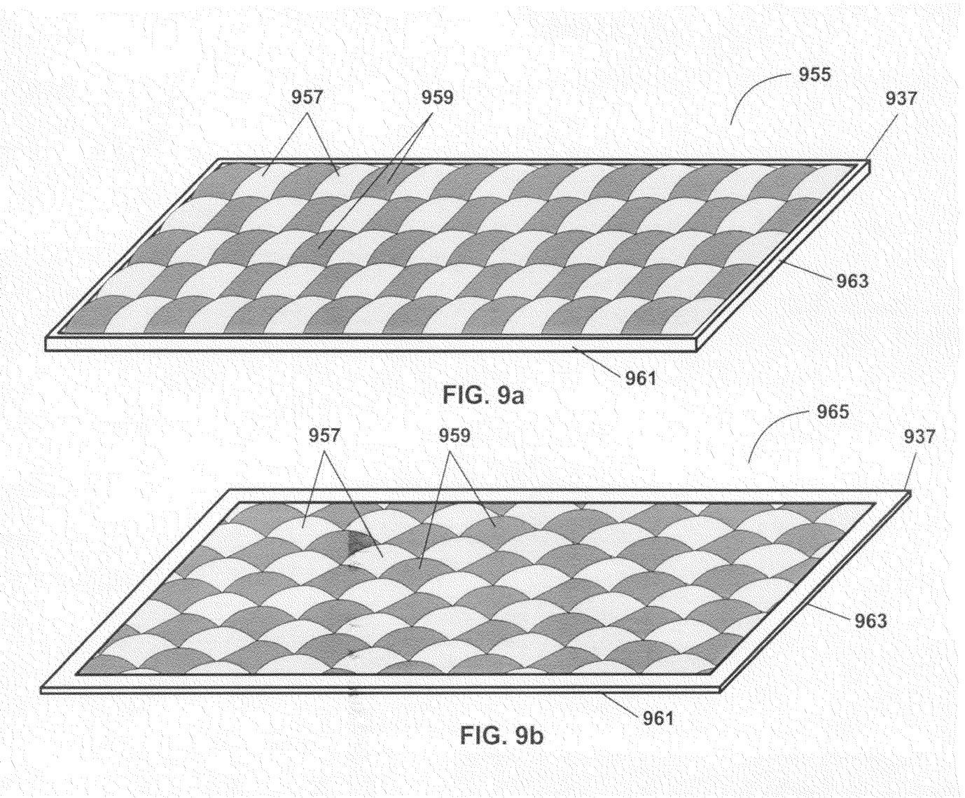

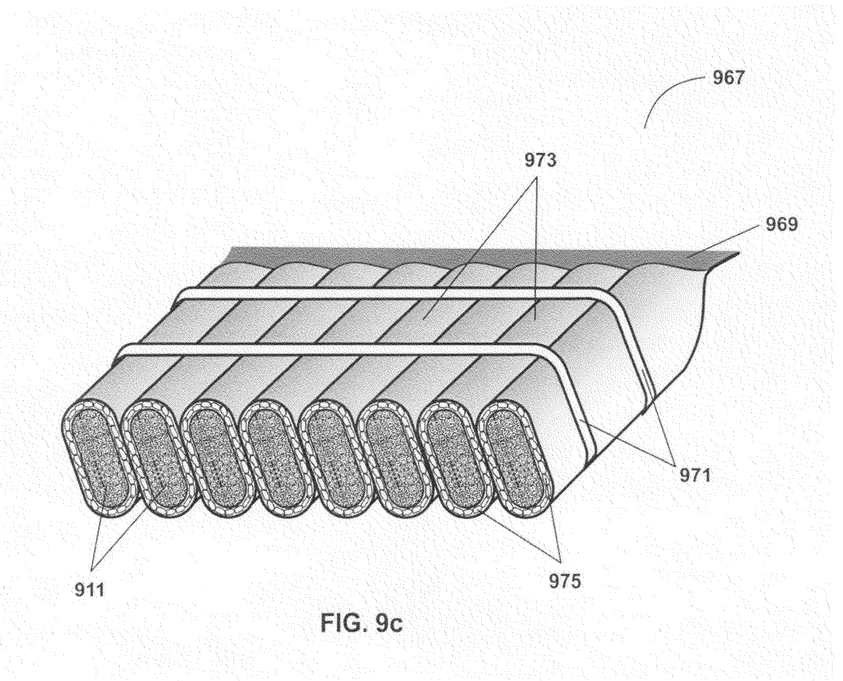

FIG. 9a, b—diagrammatic shows next embodiment of the present invention. It is a perspective view of that embodiment wherein an anti-skid mat's receptacle is made by means mutual stranding of the longitudinal 957 and transverse 959 hoses and said hoses are fastened in such a manner that organize uniform segmented anti-skid mat.

### On FIG. 9a:

955—a diagrammatic image of an anti-skid mat which receptacle is made from hoses filled out with a granular substance by means mutual stranding of the longitudinal 957 and transverse 959 hoses and said hoses are fastened in such a manner that organize uniform segmented anti-skid mat;
937—a means for a fastening of filled out with a granular substance hoses among themselves, made in the form of a framework, which can be made from an empty hose; the longitudinal 957 and transverse 959 hoses are intertwined in parallel corresponding edges of the longitudinal and transverse of an anti-skid mat 955.
961—the longitudinal edge of an anti-skid mat;
963—the transverse edge of an anti-skid mat;

On FIG. 9b: the longitudinal 957 and transverse 959 hoses are intertwined at an angle to the longitudinal edge 961 and transverse edge 963 of an anti-skid mat 965.

937—a means for a fastening of filled out with a granular substance hoses among themselves, made in the form of a framework (on the FIG. 9b shown said means made like a belt from an empty hose).

FIG. 9c—diagrammatic shows a fragment of next embodiment of the present invention. It is a cross sectional view of a fragment of that embodiment wherein an anti-skid mat's receptacle is made from the hoses arranged in overlap and said hoses are fastened in such a manner that organize uniform segmented anti-skid mat. There are many variants to fasten the hoses in such a manner that organize uniform segmented anti-skid mat. On the FIG. 9c shown said means made in a form of belt binding to the hoses and in a form of insertion and/or binding of hoses. As a variant, in function of the belt can be used an empty hose.

### On the FIG. 9c:

967—an anti-skid mat;
911—a granular substance poured into hoses;
969—a means for a fastening of filled out with a granular substance hoses among themselves, made in a form of insertion and/or binding by belts 971;
973—the hoses formed an anti-skid mat's receptacle arranged in overlap;
975—the walls of the hoses.

The embodiments shown on the FIG. 9a, b, and c possess advantages of the segmented anti-skid mats.

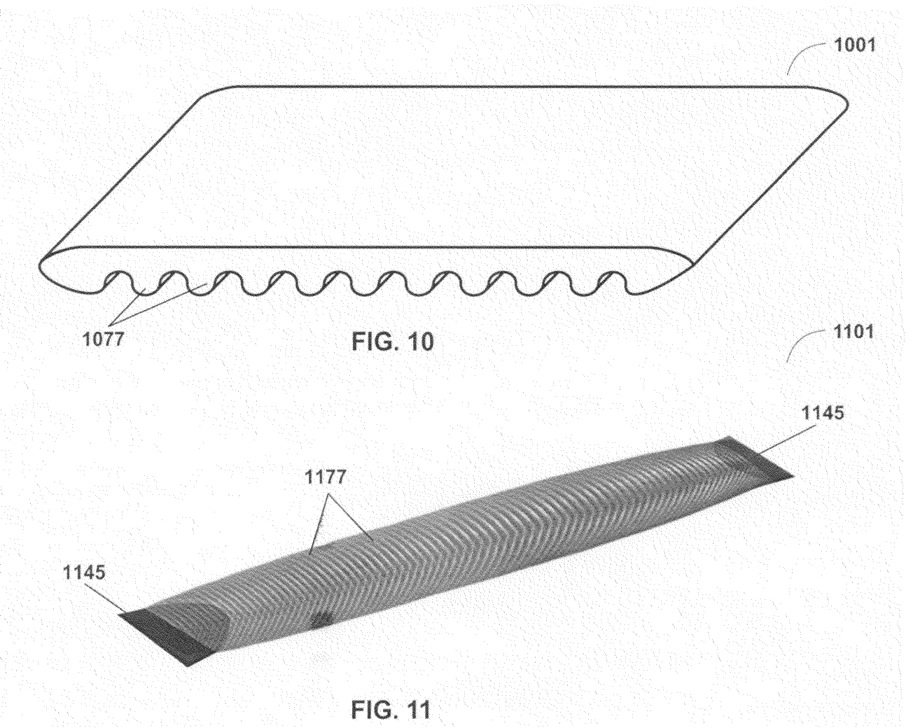

FIG. 10—diagrammatic shows another embodiment of the present invention. It is a perspective view of that embodiment wherein at least a bottom wall of said receptacle of said anti-skid mat is crimped.

### On FIG. 10:

1001—an anti-skid mat;
1077—a crimped bottom of anti-skid mat.

If the crimps are located on the bottom surface of an anti-skid mat's receptacle, the granular substance under pressure of vehicle concentrate the pressure on a bottom surface of an anti-skid mat predominantly in the hollows of crimps. At that coupling an anti-skid mat with a contacting slippery surface of the iced over a road thus improves.

In case the road surface is covered by snow, the influence of weight of a vehicle creates in a snow cover deeper indents, and more effectively resists to shift migrations of snow by an anti-skid mat. If the crimps are located on the top surface (not shown) of an anti-skid mat's receptacle, crimps under the influence of weight vehicles go deep in granular substance and the clutch between wheels of a vehicle and a surface of mat improves even more.

Performance an anti-skid mat's receptacle with crimps raises clutch extent receptacle with granular material and effectively resists to shift migrations granular material inside a receptacle under the influence of revolving wheels of a vehicle.

FIG. 11—diagrammatic shows another embodiment of the present invention. It is a perspective view of that embodiment wherein said receptacle of said anti-skid mat is made from one crimped hose.

### On FIG. 11:

1101—an anti-skid mat is made from one crimped hose with closed openings;
1145—insertion part of a hose;
1177—crimps.

This embodiment possesses all advantages previous embodiment, presented on FIG. 10, and besides, illustrates an instance of use of a finished material—crimped hoses, including salvaging worked out the resource of crimped hoses for manufacturing of anti-skid mats.

It is necessary to mean that used for manufacturing an anti-skid mat's receptacles crimped hoses, depending on their first shape and sizes, if necessary, can be flattened to or after filling up said receptacle by granular material.

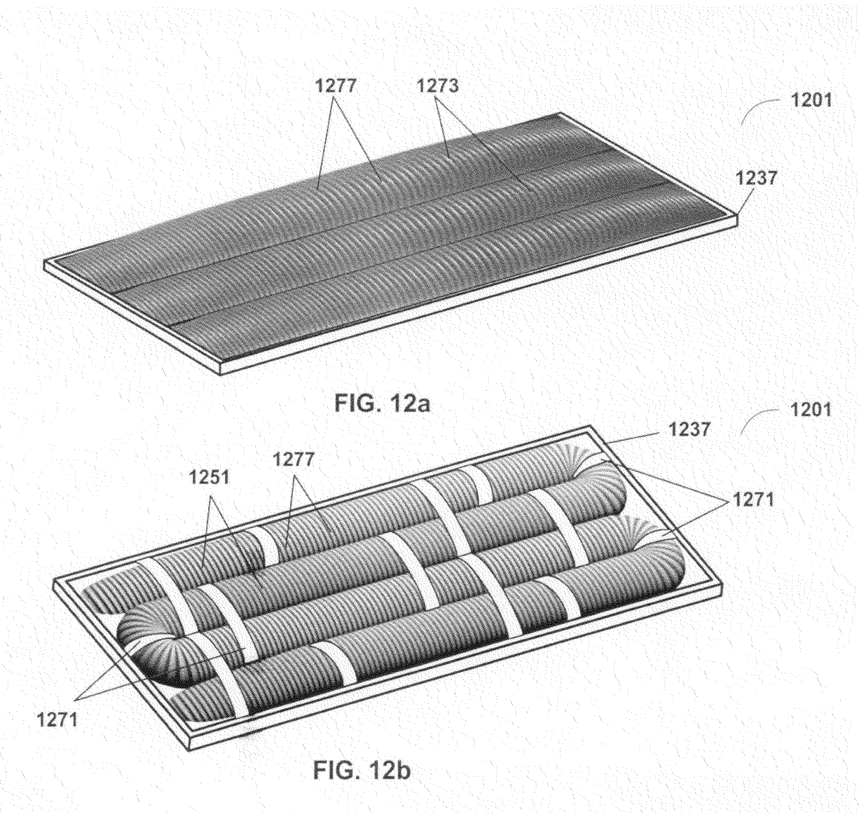

FIG. 12a—diagrammatic shows still another embodiment of the present invention. It is a perspective view of that embodiment wherein an anti-skid mat's receptacle is made from two or more crimped hoses 1273 and said hoses are fastened in such a manner that organize uniform segmented anti-skid mat. A means for a fastening of filled out with a granular substance hoses among themselves, made in the form of a framework 1237.

FIG. 12b—diagrammatic shows an alternative of the present invention. It is a perspective view of that embodiment wherein an anti-skid mat's receptacle is made from one crimped hose, said hose is made in the form of a coil, and separate segments 1251 of said coil are fastened in such a manner that organize uniform segmented anti-skid mat. A means for a fastening of filled out with a granular substance separate segments 1251 of crimped hose made in the form of a framework 1237 and belts 1271.

The separate crimped hoses and crimped hoses are made in the form of a coil can be combine (not shown) and fastened in such a manner that organize uniform segmented anti-skid mat.

### On FIG. 12a, b:

1201—an anti-skid mat is made from one crimped hose formed a coil;
1237—a means for a fastening of filled out with a granular substance hoses among themselves, made in the form of a framework;
1271—belts;
1251—separate segments of crimped hose formed a coil;
1273—the separate crimped hoses formed an anti-skid mat's receptacle;
1277—crimps on the hoses.

These embodiment combines advantages of anti-skid mat, which receptacle it is made from crimped hose, shown on the FIG. 11, with advantages of segmented anti-skid mats shown on the FIG. 8 b, c, d and FIG. 9 a, b, c.

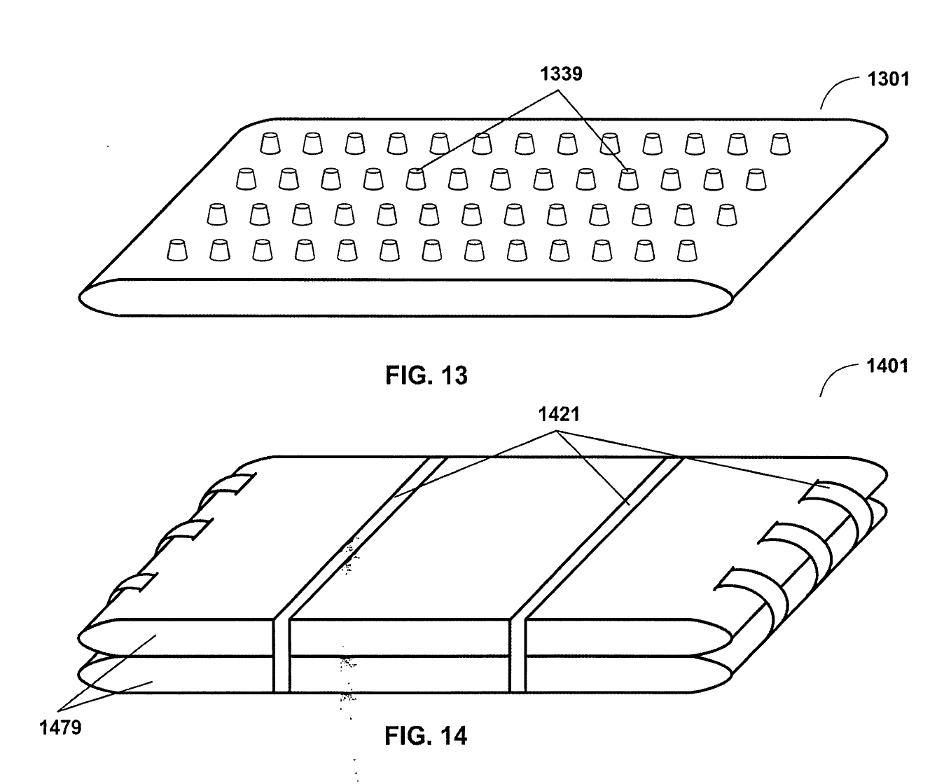

FIG. 13—diagrammatic shows still another embodiment of the present invention. It is a perspective view of that embodiment wherein an anti-skid mat's receptacle is made from a material with the protuberances 1339 and protuberances directed outside of the receptacle. Also protuberances can direct inside of the receptacle (not shown).

In particular, an anti-skid mat's receptacles can be made from a material for a conveyor belt, especially, from conveyor belts which have served their resource.

### On FIG. 13:

1301—an anti-skid mat, which receptacle is made from a material with the protuberances 1339 facing outside.

In case of when the top surface of an anti-skid mat's receptacle provided with protuberances, the clutch between wheels of a vehicle and a surface of mat improves even more.

In case of when the bottom surface of an anti-skid mat's receptacle is provided with protuberances, they under the influence of weight of a vehicle create indents in a snow cover, and more effectively resists to shift migrations of snow by an anti-skid mat. The clutch between a surface of mat and a slippery surface of a road thus improves even more.

In case of when the protuberances directed inside of the receptacle (not shown) protuberances under the influence of weight vehicles goes deep in granular substance and the clutch between surface of receptacle and a granular substance improves. At the same time possibility of displacement the surface of receptacle relatively to a granular substance under the influence of revolving wheels of a vehicle reduced. It raises efficiency of functioning of an anti-skid mat.

FIG. 14—diagrammatic shows another embodiment of the present invention. It is a perspective view of that embodiment wherein an anti-skid mat is made at least bilayer.

### On FIG. 14:

1401—an anti-skid mat;
1421—belts;
1479—layers of an anti-skid mat.

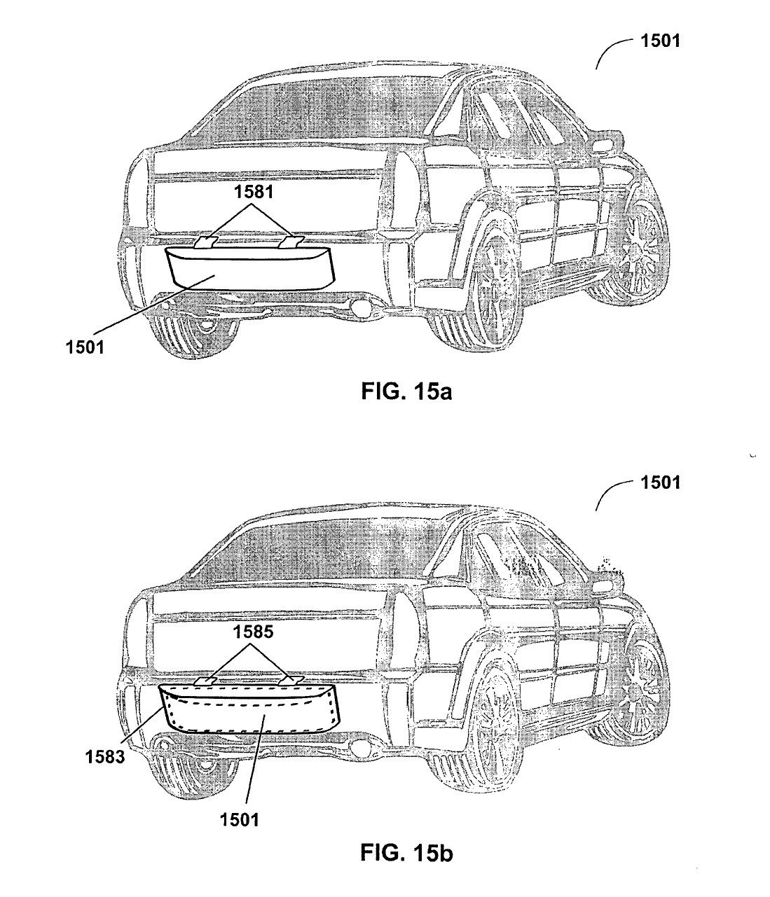

FIG. 15a—diagrammatic shows still another embodiment of the present invention. It is a perspective view of that embodiment wherein an anti-skid mat providing with a means for fixing over a car bumper. With this design an anti-skid mat acquires new properties, namely, can be used as the protector of a car's bumper.

FIG. 15b—diagrammatic shows an alternative embodiment of the present invention. It is a perspective view of that embodiment wherein an anti-skid mat providing with an anti-skid mat's cover providing with a means for fixing said cover with placed inside said anti-skid mat over a car bumper. With this design an anti-skid mat acquires new properties, namely, can be used as a protector of a car's bumper.

### On FIG. 15a, b:

1501—an anti-skid mat;
1581—a means for fixing an anti-skid mat over a car bumper.
1583—a cover of anti-skid mat with a means 1585 for fixing said cover with placed inside said anti-skid mat over a car bumper.

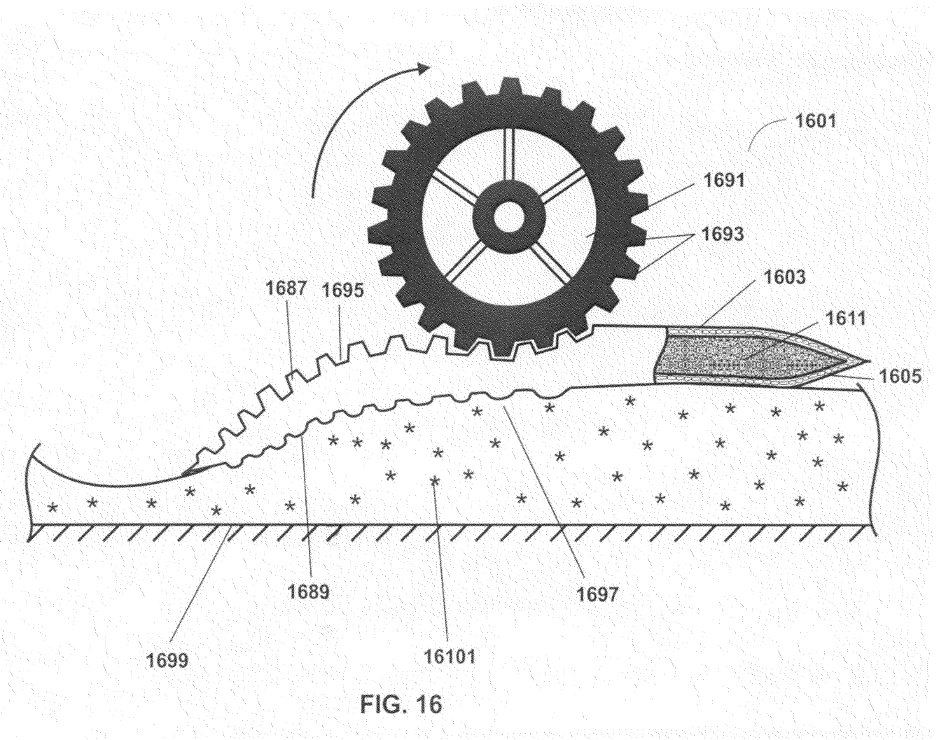

FIG. 16—diagrammatic shows how an anti-skid mat works.

### On FIG. 16:

1601—an anti-skid mat with a receptacle from a flexible material;
1603—the top surface of the receptacle before contact with the vehicle's wheels;
1605—the bottom surface of the receptacle before contact with the vehicle's wheels;
1611—a granular substance poured into receptacle;
1687—the top surface of the receptacle after contact with the vehicle's wheels;
1689—the bottom surface of the receptacle after contact with the vehicle's wheels;
1691—the vehicle's wheel;
1693—treads of the tire of the vehicle's wheel;
1695—traces of tire's tread on the top surface of the receptacle after contact with the vehicle's wheels;
1697—traces of tire's tread on the bottom surface of the receptacle after contact with the vehicle's wheels;
1699—pavement;
16101—snow.

After an anti-skid mat is enclosed under of vehicle's wheel 1691, tread 1693 of the vehicle's wheel's tire under the influence of weight of vehicle and twirls of a wheel 1691 starts to press in the top surface 1687 of the anti-skid mat in a granular substance 1611 poured into receptacle. Offered an anti-skid mat possesses unique properties: in a usual condition a granular substance 1611 is in receptacle in a free state and its separate particles under the influence of this or that force applied to them can move from each other inside receptacle. For example, if receptacle to shake or turn over, freely moving particles move inside of a receptacle and accept other position and a site. Moving said particles is interfered only by the forces of a dry friction originating between particles of granular substance 1611 and material of a receptacle, and between separate particles of granular substance 1611. But as particles of granular substance 1611 are in a free state and the distance between them is great, a frictional force—is insignificant.

After an anti-skid mat it is enclosed under wheel 1691 of vehicle, and vehicle starts to move on an anti-skid mat, tread 1693 of the tire of the vehicle's wheel 1691 under the influence of weight of vehicle and twirls of a wheel 1691 starts to press the top surface of the anti-skid mat in a granular substance 1611 poured into receptacle. Particles of a granular substance 1611 under the influence of the originated forces start to move inside of a receptacle, as much as possible coming nearer to each other, the frictional force between them sharply increases, as the frictional force is proportional to the imposed load. Because of sharply increased friction with each other of the particles, they cannot be displaced any more so easily from each other, in a granular substance 1611 at pressure rise, there ensues sharp transition from a pliability regime to a pressure regime.

After contact with the vehicle's wheels 1691 the anti-skid mat is strained, its bottom surface fits roughnesses covered with snow 16101 or ice of a surface of road, and on the top of surface 1687 of the anti-skid mat remain traces 1695 of tire's tread 1693. Thus traces 1695 of a tread 1693 are fixed on a surface of an anti-skid mat that sharply raises extent of the clutch of a tread 1693 with an anti-skid mat.

At the same time, as approaching underlying layers of a granular substance the extent of an adhesion of particles of a granular substance among themselves gradually decreases owing to a dissipation of energy and decrease in specific pressure. For this reason on the bottom surface 1689 of anti-skid mat the form of traces of a tread has a little degraded character. Nevertheless, sections of the bottom surface being under pressure 1689 of anti-skid mat take root into the surface of a roadway covered with snow and are better linked to the iced over surface that raises its clutch with the anti-skid mat.

Shift deformations of anti-skid mat, originating at twirl of vehicle's wheel, owing to energy dissipation in granular substance fade in a direction from the overhead layers to the bottom layers. Because of it sliding the anti-skid mat on a slippery surface decreases and ejection of said anti-skid mat from under the vehicle's wheel is prevented during its rotation. Features of work separate embodiments of the present invention are shown above.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. An anti-skid mat for facilitating movement of a vehicle on a slippery surface having a top surface and a bottom surface, wherein said anti-skid mat is made as a receptacle from a flexible material into which a granular substance is poured in and wherein said receptacle of said anti-skid mat is segmented or not segmented.

2. The anti-skid mat as defined in claim 1 wherein said receptacle of said anti-skid mat is made with closable opening for possibility of substitution or replenishment of said granular material.

3. The anti-skid mat as defined in claim 1 wherein said receptacle of said anti-skid mat is made from a slip resistant material and/or covered with an anti-skid coating.

4. The anti-skid mat as defined in claim 1 wherein said receptacle of said anti-skid mat has an envelope from a frictional material located outside of said receptacle or alternatively said receptacle is made from a grinding ribbon, with the tightened abrasive particles, at least, on its external surface.

5. The anti-skid mat as defined in claim 1 wherein said receptacle of said anti-skid mat is made from an air-locked material and the bottom wall and/or the top wall of said anti-skid mat's receptacle has hollows on the external and/or the internal side.

6. The anti-skid mat as defined in claim 1 wherein said receptacle of said anti-skid mat is reinforced by a reinforcing fabric from a flexible material.

7. The anti-skid mat as defined in claim 6 wherein said reinforcing fabric of said receptacle of said anti-skid mat is located into said material of said receptacle, thus that the thickness of a wall of said receptacle in the field of the elements forming a set group of cells said reinforcing fabric, exceeds a thickness of a wall of said receptacle in corresponding set group of cells, at least on the external surface of said receptacle.

8. The anti-skid mat as defined in claim 7 wherein said receptacle of anti-skid mat is made from an air-locked material.

9. The anti-skid mat as defined in claim 6 wherein said reinforcing fabric of said receptacle of said anti-skid mat is made in the form of an envelope located outside of said receptacle, and/or in the form of a liner located inside of said receptacle of said anti-skid mat.

10. The anti-skid mat as defined in claim 6 wherein said reinforcing fabric of said receptacle of said anti-skid mat is made with the minimum cross size of a cell exceeding greatest fineness of grains of a granular substance in the following ratio of sizes:

| | |
|---|---|
| The fineness of grains, mm | The minimum cross size of a cell, mm |
| | |
|---|---|
| 0.7-2 | 5-7 |
| Over 2 up to 3 | 7-10 |
| Over 3 up to 10 | 12-20 |

11. The anti-skid mat as defined in claim 1 wherein the granular substance for pouring said receptacle of said anti-skid mat is made from seed and/or crushed seed and/or crushed wood, treated with water-repellent coating.

12. The anti-skid mat as defined in claim 1 wherein said receptacle of said anti-skid mat is made, at least, from one hose and wherein in case if said anti-skid mat is made from two or more separate hoses said hoses are fastened in such a manner that organize uniform segmented anti-skid mat.

13. The anti-skid mat as defined in claim 11 wherein said receptacle of said anti-skid mat is made from a hose and wherein said hose is made in the form of a coil, and separate segments of said coil are fastened in such a manner that organize uniform segmented anti-skid mat.

14. The anti-skid mat as defined in claim 11 wherein said receptacle of said anti-skid mat is made by means mutual stranding of the longitudinal and transverse hoses and said hoses are fastened in such a manner that organize uniform segmented anti-skid mat.

15. The anti-skid mat as defined in claim 11 wherein said receptacle of said anti-skid mat is made from the hoses arranged in overlap and said hoses are fastened in such a manner that organize uniform segmented anti-skid mat.

16. The anti-skid mat as defined in claim 1 wherein at least a bottom wall of said receptacle of said anti-skid mat is crimped.

17. The anti-skid mat as defined in claim 16 wherein said receptacle of said anti-skid mat is made, at least, from one crimped hose.

18. The anti-skid mat as defined in claim 17 wherein two or more said separate crimped hoses are fastened in such a manner that organize uniform segmented anti-skid mat, and/or wherein said crimped hose or hoses are made in the form of a coil, and separate segments of said coil or coils are fastened in such a manner that organize uniform segmented anti-skid mat.

19. The anti-skid mat as defined in claim 1 wherein said receptacle of said anti-skid mat is made from a material with the protuberances and protuberances directed outside and/or inside of the receptacle.

20. The anti-skid mat as defined in claim 1 wherein said anti-skid mat is made at least bilayer and wherein said anti-skid mat is collapsible or nor collapsible.

21. The anti-skid mat as defined in claim 1 wherein said anti-skid mat providing with a means for fixing over a car bumper and/or alternatively providing with anti-skid mat's cover providing with a means for fixing said cover with placed inside said anti-skid mat over a car bumper.

22. An anti-skid mat for facilitating movement of a vehicle on a slippery surface having a top surface and a bottom surface, wherein said anti-skid mat providing with a means for fixing over a car bumper and/or alternatively providing with an anti-skid mat's cover providing with a means for fixing said cover with placed inside said anti-skid mat over a car bumper.

23. A method for manufacturing an anti-skid mat comprising the steps of:
a) making a receptacle from a flexible material,
b) filling said receptacle by a granular substance,
c) closing said receptacle.

24. The method for manufacturing an anti-skid mat as defined in claim 23 wherein said receptacle of said anti-skid mat is made from a flexible, air-locked and reinforced by a flexible reinforcing fabric material, and said material is subjected to shaping, at least on one side, in area of an adjusted set group of cells for the purpose of deriving of hollows inside cells of said set group.

25. A method for manufacturing an anti-skid mat's material wherein said anti-skid mat's material making from a flexible, air-locked and reinforced by a flexible reinforcing fabric material, thus said anti-skid mat's material is subjected to shaping, at least on one side, in area of an adjusted set group of cells for the purpose of deriving of hollows inside cells of said set group.
